(19) United States
(12) Patent Application Publication
(10) Pub. No.: US 2025/0344187 A1
(43) Pub. Date: Nov. 6, 2025

(54) PAGING CLUSTERING IN LOW LOAD CELL

(71) Applicant: Nokia Technologies Oy, Espoo (FI)

(72) Inventors: Mads LAURIDSEN, Aalborg (DK); Daniela LASELVA, Aalborg (DK); Chunli WU, Beijing (CN); Jussi-Pekka KOSKINEN, Oulu (FI)

(21) Appl. No.: 18/870,726

(22) PCT Filed: Jun. 6, 2022
(86) PCT No.: PCT/CN2022/097064

§ 371 Date: Dec. 2, 2024

(51) Int. Cl. H04W 68/02; H04L 5/00; H04W 56/00; H04W 74/0833

(52) U.S. Cl. CPC H04W 68/02; H04L 5/0051; H04W 56/0015; H04W 74/0833

(57) ABSTRACT

Systems, methods, apparatuses, and computer program products for paging clustering in low load cell are provided. A method may include receiving, from a network element, clustered paging information comprising at least a paging window configuration. The method may also include determining a paging occasion within a clustered paging window based on the paging window configuration. The method may further include monitoring the paging occasion within the clustered paging window.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for paging clustering in low load cell.

### BACKGROUND

Examples of mobile or wireless telecommunication systems may include the Universal Mobile Telecommunications System (UMTS), Long Term Evolution (LTE), LTE-Advanced (LTE-A), LTE-A Pro, and/or fifth generation (5G) or New Radio (NR) telecommunications systems, and future generation of telecommunications systems. Fifth generation (5G) telecommunications systems refer to the next generation (NG) of radio access networks and network architectures for core networks. A 5G telecommunication system is mostly based on new radio (NR) radio access technology (5G NR), but a 5G (or NG) network can also build on E-UTRAN. It is estimated that 5G NR will provide bitrates on the order of 10-20 Gbit/s or higher, and will support at least enhanced mobile broadband (eMBB) and ultra-reliable low-latency communication (URLLC) as well as massive machine-type communication (mMTC). 5G NR is expected to deliver extreme broadband and ultra-robust, low-latency connectivity and massive networking to support the Internet of Things (IoT).

### SUMMARY

Some example embodiments may be directed to a method. The method may include receiving, from a network element, clustered paging information comprising at least a paging window configuration. The method may also include determining a paging occasion within a clustered paging window based on the paging window configuration. The method may further include monitoring the paging occasion within the clustered paging window.

Other example embodiments may be directed to an apparatus. The apparatus may include at least one processor and at least one memory including computer program code. The at least one memory and computer program code may also be configured to, with the at least one processor, cause the apparatus at least to receive, from a network element, clustered paging information comprising at least a paging window configuration. The apparatus may also be caused to determine a paging occasion within a clustered paging window based on the paging window configuration. The apparatus may further be caused to monitor the paging occasion within the clustered paging window.

Other example embodiments may be directed to an apparatus. The apparatus may include means for receiving, from a network element, clustered paging information comprising at least a paging window configuration. The apparatus may also include means for determining a paging occasion within a clustered paging window based on the paging window configuration. The apparatus may further include means for monitoring the paging occasion within the clustered paging window.

In accordance with other example embodiments, a non-transitory computer readable medium may be encoded with instructions that may, when executed in hardware, perform a method. The method may include receiving, from a network element, clustered paging information comprising at least a paging window configuration. The method may also include determining a paging occasion within a clustered paging window based on the paging window configuration. The method may further include monitoring the paging occasion within the clustered paging window.

Other example embodiments may be directed to a computer program product that performs a method. The method may include receiving, from a network element, clustered paging information comprising at least a paging window configuration. The method may also include determining a paging occasion within a clustered paging window based on the paging window configuration. The method may further include monitoring the paging occasion within the clustered paging window.

Other example embodiments may be directed to an apparatus that may include circuitry configured to receive, from a network element, clustered paging information comprising at least a paging window configuration. The apparatus may also include circuitry configured to determine a paging occasion within a clustered paging window based on the paging window configuration. The apparatus may further include circuitry configured to monitor the paging occasion within the clustered paging window.

Certain example embodiments may be directed to a method. The method may include transmitting, to a user equipment, a clustered paging information comprising at least a paging window configuration. The method may also include determining that the user equipment needs to be paged. The method may further include paging the user equipment based on the paging window configuration. According to certain example embodiments, the clustered paging window may include one or more paging frames, or one or more paging occasions.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, a clustered paging information comprising at least a paging window configuration. The apparatus may also be caused to determine that the user equipment needs to be paged. The apparatus may further be caused to page the user equipment based on the paging window configuration. According to certain example embodiments, the clustered paging window may include one or more paging frames, or one or more paging occasions.

Other example embodiments may be directed to an apparatus. The apparatus may include means for transmitting, to a user equipment, a clustered paging information comprising at least a paging window configuration. The apparatus may also include means for determining that the user equipment needs to be paged. The apparatus may further include means for paging the user equipment based on the paging window configuration. According to certain example embodiments, the clustered paging window may include one or more paging frames, or one or more paging occasions.

In accordance with other example embodiments, a non-transitory computer readable medium may be encoded with instructions that may, when executed in hardware, perform a method. The method may include transmitting, to a user equipment, a clustered paging information comprising at least a paging window configuration. The method may also include determining that the user equipment needs to be paged. The method may further include paging the user equipment based on the paging window configuration. According to certain example embodiments, the clustered paging window may include one or more paging frames, or one or more paging occasions.

Other example embodiments may be directed to a computer program product that performs a method. The method may include transmitting, to a user equipment, a clustered paging information comprising at least a paging window configuration. The method may also include determining that the user equipment needs to be paged. The method may further include paging the user equipment based on the paging window configuration. According to certain example embodiments, the clustered paging window may include one or more paging frames, or one or more paging occasions.

Other example embodiments may be directed to an apparatus that may include circuitry configured to transmit, to a user equipment, a clustered paging information comprising at least a paging window configuration. The apparatus may also include circuitry configured to determine that the user equipment needs to be paged. The apparatus may further include circuitry configured to page the user equipment based on the paging window configuration. According to certain example embodiments, the clustered paging window may include one or more paging frames, or one or more paging occasions.

### BRIEF DESCRIPTION OF THE DRAWINGS

For proper understanding of example embodiments, reference should be made to the accompanying drawings, wherein:

FIG. 1 illustrates an example impact of a synchronization signal and physical broadcast channel block burst transmission periodicity and resource usage on energy consumption.

FIG. 2 illustrates an example paging procedure.

FIG. 3 illustrates an example paging transmission window and extended discontinuous reception.

FIG. 4 illustrates an example combination of a clustered paging window and additional reference signals, according to certain example embodiments.

FIG. 5 illustrates an example flow diagram of a procedure, according to certain example embodiments.

FIG. 6 illustrates an example paging window, according to certain example embodiments.

FIG. 7 illustrates an example of another paging window, according to certain example embodiments.

FIG. 8 illustrates an example signal flow diagram, according to certain example embodiments.

FIG. 9 illustrates an example flow diagram of a method, according to certain example embodiments.

FIG. 10 illustrates an example flow diagram of another method, according to certain example embodiments.

FIG. 11 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for paging clustering in low load cell.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or “network”, or other similar language throughout this specification may be used interchangeably.

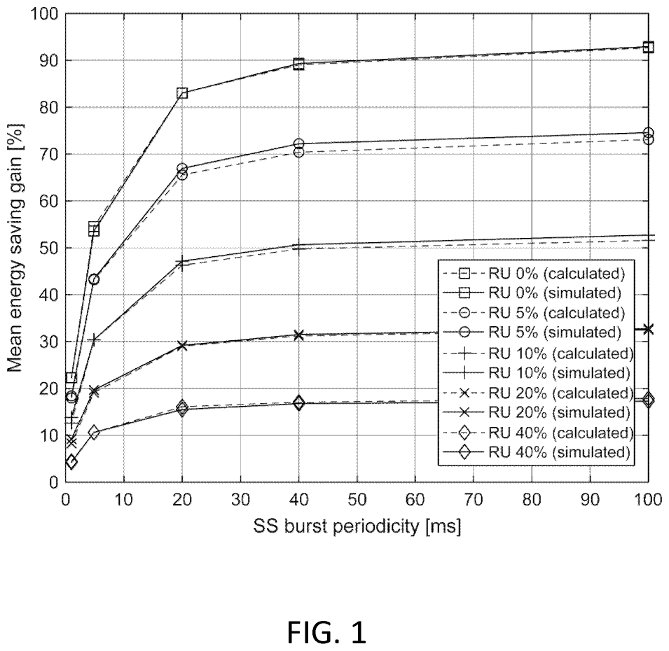

In New Radio (NR), adaptation of the synchronization signal and physical broadcast channel (PBCH) block (SSB) transmission periodicity may enable network energy savings due to longer periods, and the longer periods may enable longer sleep times between transmissions for a base station (BS). FIG. 1 illustrates an example impact of SSB burst transmission periodicity and resource usage (RU) on energy consumption. In particular, FIG. 1 illustrates potential gains (in a particular scenario) when the SSB burst transmission periodicity is adjusted. As illustrated in FIG. 1, changing the SSB transmission periodicity (and likewise system information broadcast (SIB) periodicity) may impact a user equipment's (UE's) ability to obtain time/frequency synchronization of a current cell, detect and measure new/target cells, obtain information needed for cell access, and initiate a connection setup. As such, careful consideration may be needed before such adjustments are made.

The technical standards of the 3^{rd} Generation Partnership Project (3GPP) describe UE power saving, and obtaining time/frequency synchronization with a network prior to being ready to monitor for paging. In some instances, a tight synchronization may be needed for the UE to receive a paging message in case the paging downlink control information (DCI) indicates that the UE is paged.

During synchronization procedures, if the SSB burst transmission periodicity is extended, the UEs monitoring for paging in the cell may need to wakeup for a longer period of time in advance of the paging occasion, where the time scales with the SSB burst transmission periodicity. For instance, assuming that the UE needs to receive 2 SSB bursts prior to starting the paging monitoring, the time the UE needs to wakeup in advance may scale with the SSB burst periodicity. For example, with a periodicity of 20 ms, the UE may wakeup up to 40 ms in advance (depending on alignment with PO and SSB), while if the periodicity is increased to 40 ms, the UE may now have to wakeup up to 80 ms in advance. However, a drawback of extending the SSB burst transmission periodicity is that it may impact the UE's ability to sleep and save energy. In such situations, 3GPP has specified that tracking reference signals (TRS) may be made available to ide/inactive UEs. The availability of TRS may enable the UEs to achieve synchronization by receiving the TRSs in addition to/instead of the SSB. Further, depending on the network configuration, the TRS may be available more often and/or at more convenient points in time than SSBs. However, the network may not be required to transmit such TRSs if there are no radio resource control (RRC) connected to the UEs in need of it, which means that the network may not be required to transmit the TRS only for the benefit of RRC idle/inactive UEs.

Currently, paging occasions for UEs in a cell may be uniformly distributed in the time domain, and short enough periodic SSB transmissions may need to be configured to ensure short latency for paging reception. However, the current paging occasions for UEs do not allow network (NW) energy saving for SSB transmission even when in a low load scenario when there is no UE, or very few UEs, are to be paged. As such, certain example embodiments may address at least the issue of SSB burst transmission periodicity adaptation in a low load scenario, where a limited number of (RRC idle/inactive) UEs are camping and monitoring for paging in a cell. This may, for example, be a cell during night time. However, example embodiments should not be construed to be limited to just this scenario.

In the paging occasion, if the SSB burst transmission periodicity is extended, the UEs monitoring according to legacy paging procedures may need to potentially wakeup a long time before the paging occasion due to the need to receive 1-3 SSB bursts for synchronization. Thus, in certain example embodiments, it may be possible to provide paging enhancements to obtain network energy savings without impacting the UEs' ability to timely monitor for paging, and save UE energy. Certain example embodiments may also achieve more efficient operation dynamically and/or semi-statically, and finer granularity adaptation of transmissions and/or receptions in one or more network energy saving techniques in time, frequency, spatial, and power domains, with potential support/feedback from the UE, and potential UE assistance information.

According to 3GPP, a UE may assume that half frames with synchronization signal (SS)/PBCH blocks occur with a periodicity of 2 frames. This limitation suggests that a cell, which targets to increase the SSB burst transmission periodicity above 2 radio frames (i.e., 20 ms), may not be detectable by UEs performing the initial cell selection. Thus, a cell of a capacity layer may operate with a longer SSB burst transmission periodicity if support for legacy UEs (initial cell search) need not be ensured. The legacy UEs here may correspond to UEs that implement the 3GPP specification that defines the 20 ms periodicity assumption described above.

3GPP may also define a system frame number (SFN) for a paging frame (PF). For instance, the SFN for the PF may be determined by (SFN+PF_offset) mod T=(T div N)*(UE_ID mod N), and Index (i_s), indicates that the index of the paging occasion (PO) is determined by i_s=floor (UE_ID/N) mod Ns. According to the RRC specification, N may be defined N=T/x, where x=[1, 2, 4, 8, 16], and T is the paging cycle (e.g., 128 radio frames). If x=16, T=128, N=T/x=128/16=8, and PF_offset=0, then PF may be defined by (SFN+PF_offset) mod T=(T div N)*(UE_ID mod N), which becomes ((SFN+0) mod 128=(16)*(UE_ID mod 8). This means that the UEs are grouped into PFs, which occur every 16th radio frames according to the smallest currently allowed configuration, and the UE's specific PF is based on the UE_ID. Additionally, the specific PF may be located at radio frame 0*16, 1*16, 2*16, and so forth.

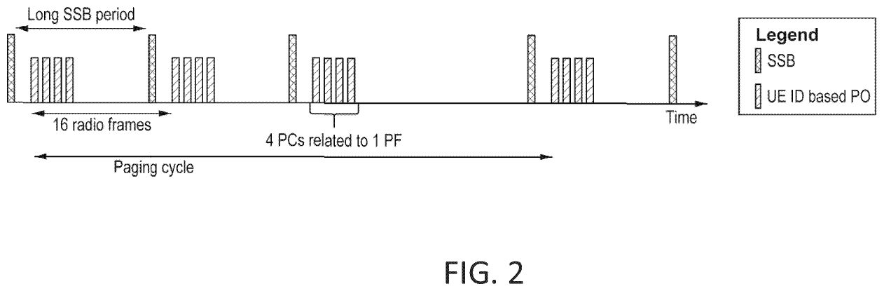

FIG. 2 illustrates an example legacy paging procedure. In particular, FIG. 2 illustrates a scenario with a long SSB period where some UEs need to wakeup for a long period of time in advance if they need to receive 3 SSB bursts prior to their PO. As illustrated in FIG. 2, if a larger paging load is needed, either x can be set to a value below 16, or more POs may be configured per PF. For example, with up to 4 POs per PF (defined by the parameter ns), a total of 32*4*(1000/160)=800 unique paging attempts per second are possible in a paging cycle (given maxNrofPageRec=32). However, since the UEs may be distributed into 4 POs every 16th radio frame, the NW may also provide Random access (RA) occasions in a similar distributed fashion not to delay any UE responding to the paging.

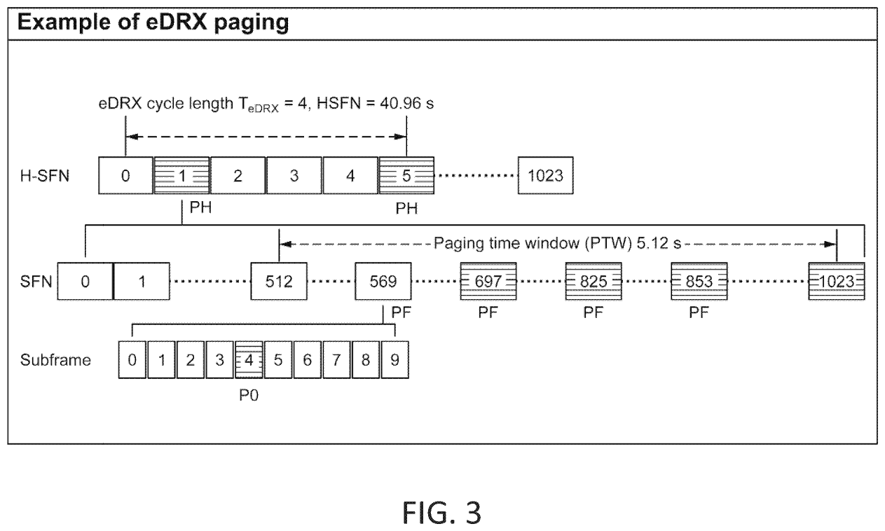

FIG. 3 illustrates an example of a paging time window (PTW) and eDRX. In view of FIG. 3, 3GPP describes UEs that are configured with extended discontinuous reception (DRX) (cycles in order of minutes/hours instead of seconds), and that monitor for paging within a PTW. The PTW may be UE-specific, and confined within a PTW_start point and a PTW_end point. Additionally, the PTW may be located within a paging hyperframe (PH) in which a UE may monitor for paging according to the configured paging cycle. As illustrated in FIG. 3, the PTW is located based on the PH after which the UE determines PFs within the PTW. Thus, the PTW may target monitoring of at least one PO in the extended DRX cycle, but may not enable clustering of UEs and short paging delay as each UE derives its own PF/PO/PTW based on a UE_ID. Furthermore, the PTW may not allow the NW to save energy even when the UEs monitor paging based on an eDRX cycle.

In view of the drawbacks exhibited in conventional paging occasions in a low load cell scenario, certain example embodiments may enable a cell to operate with a paging cluster, and to allow long SSB burst transmission periodicity for NW energy saving without impacting paging latency and the battery life of UEs monitoring for paging. For instance, in certain example embodiments, the cell of the network may cluster RRC idle/inactive UEs to monitor for paging in a dedicated paging window per paging cycle, during which paging can be transmitted by the cell. The cell may also indicate in a SIB that the cell is operating in a clustered paging mode, and provide additional reference signals for synchronization in/before the clustered paging window. For instance, UEs that support the clustered paging mode may monitor POs within the clustered paging window, which may enable the network to reduce its activity outside the clustered paging window to save energy. Furthermore, the cell may be configured with a long SSB burst transmission periodicity (e.g., >20 ms) for energy savings, and the cell may configure a cluster paging operation on a separate carrier/bandwidth part (BWP) that is separate from the carrier(s)/BWP(s) used for legacy UEs.

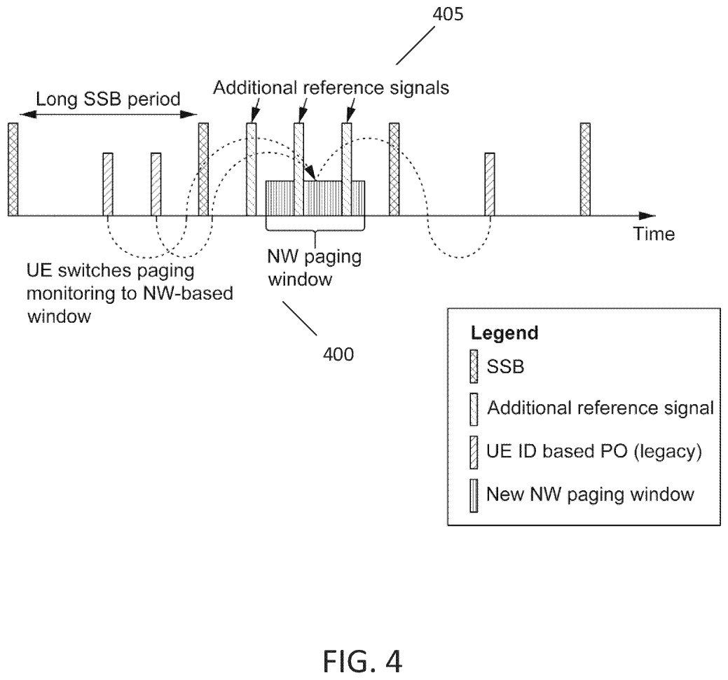

FIG. 4 illustrates an example combination of a clustered paging window 400 and additional reference signals 405, according to certain example embodiments. In particular, the example of FIG. 4 illustrates that the UEs are clustered to monitor for paging within the NW-defined paging window. According to certain example embodiments, the window 400 may be complemented with associated additional reference signals 405 enabling the UE to obtain network synchronization prior to paging acquisition, while the SSB burst transmission periodicity for outside the paging window is extended for UEs to detect the cell or measurement other than for paging monitoring. The example of FIG. 4 differs from legacy specifications where the POs for different UEs may be spread throughout the paging cycle. For instance, a first UE may have a PO at time 0 ms of the paging cycle, while a second UE may have a PO at time 160 ms, and a third UE may have a PO at time 320 ms, etc., in a 1280 ms cycle. Additionally, the legacy UE may monitor for POs anywhere on a paging cycle based on the UE ID, while in certain example embodiments, the paging monitoring may be within a clustered window, as illustrated in FIG. 4.

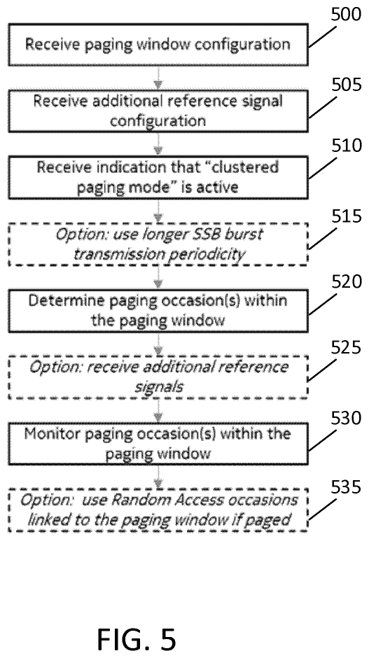

FIG. 5 illustrates an example flow diagram of a procedure, according to certain example embodiments. For instance, the example flow diagram of FIG. 5 may relate to procedures performed by the UE, where at 500, the UE may receive, from the NW, clustered paging window configuration. In certain example embodiments, the UE may rely on the NW configuration, which may define the paging window in which the PF(s) (and POs) are located. At 505, the UE may receive additional reference signal configuration from the NW. Further, at 510, the UE may receive from the NW, an indication that the NW clustered paging mode is active at the NW. In certain example embodiments, the indication may be provided in a SIB. In other example embodiments, the SIB may also indicate the clustered paging window configuration, an additional reference signal configuration, and whether legacy UEs are allowed to camp on the cell or only the UEs that support clustered paging window could camp on the cell (e.g., by setting the cell as barred for legacy UEs)

Additionally, at 515, the UE may optionally use a longer SSB burst transmission periodicity, where the SSB may be received from the NW that switched to a longer periodicity. As further illustrated in the example of FIG. 5, at 520, the UE may determine a paging occasion(s) within the clustered paging window according to the configuration received at operation 500. Further, at 525, the UE may optionally receive additional reference signals from the NW according to operation 505. For instance, when the SSB periodicity is extended, the UE (which may be in need of SSB for synchronization before paging monitoring) may need to wakeup very early. Thus, in some example embodiments, with the additional reference signals, the UE may avoid the early wakeup, and use the additional reference signals for synchronization instead. According to other example embodiments, the additional reference signals may be a primary synchronization signal (PSS) or a secondary synchronization signal (SSS), or any other reference signal. At 530, the UE may monitor paging occasion(s) within the paging window based on the paging window configuration. Additionally, at 535, the UE may optionally use RA occasions linked to the paging window if paged.

As previously discussed, the cell may cluster the RRC idle/inactive UEs in a paging window for paging monitoring. This means that the UE may rely on the NW configuration defining the paging window in which the PF(s) (and POs) are located. In some example embodiments, the paging window may include one or more PFs and/or one or more POs. Alternatively, the paging window may indicate where it starts (i.e., where PFs start).

According to other example embodiments, the UE-specific portion of the paging window that the UE monitors may be defined by modifying the legacy paging procedure. The modified procedure may result in the PFs occurring every x subframes within a paging window rather than every x radio frames in a paging cycle. For instance, the start of the window may be defined as PW_start=(SFN*10+PW_offset) mod T, where PW_offset is the paging window offset in subframes. Optionally, radio frames may be used by omitting the factor*10, and defining PW_offset in radio frames. In other example embodiments, the location of the PF within the paging window may be given as UE_PF=PF_offset+PF_spacing*(UE_ID mod N), where PF-offset defines the offset within the window, N is the number of PFs, and PF_spacing defines the space between PFs in the window. In the above expression, PF_spacing may be x slots/subframes/radio frames. Additionally, in some example embodiments, a small x value may make the paging window more dense, and in case of a low number of slots/subframes, there may not be room for many POs per PF. For instance, in some example embodiments, the small x value may be down to I subframe (i.e., PF every subframe, but may be 2, 4, or 8 subframes). This may be because of resource limitations, and a need to reserve resources for any other transmissions including, for example, SSBs/RS. In certain example embodiments, the UE selection of its PO may reuse the legacy procedure to identify the index its of the PO as i_s=floor (UE_ID/N) mod Ns). Here, “floor” may represent the operation where a value is always rounded to the smallest nearest integer (e.g., 4.3→4, 4.5→4, 4.8→4). Additionally the “mod” may be the modulo operation such as, for example, 5 mod 2 gives a remainder of 1. However, N has now been modified to define PFs inside the paging window only.

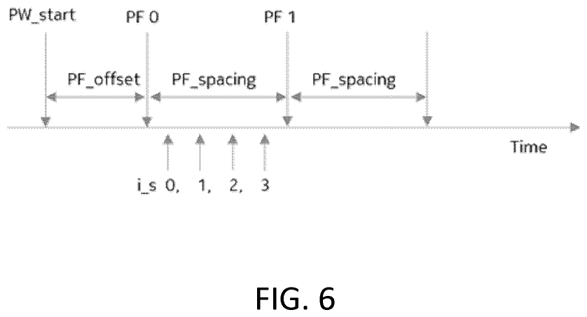

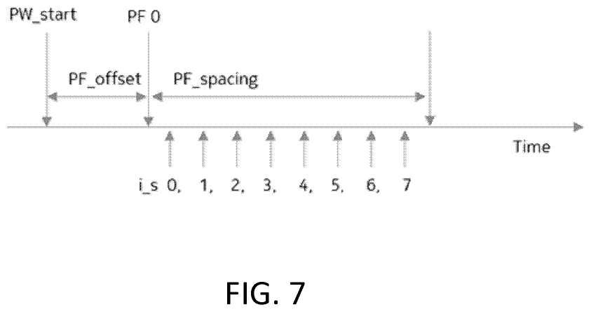

FIG. 6 illustrates an example paging window with 2 PFs and 4 POs per PF, and FIG. 7 illustrates an example paging window with 1 PF and 8 POs. In particular, FIG. 6 illustrates an example where N=2 (#PFs), and Ns=4 (#POs). However, in the example of FIG. 7, N=1 (#PFs/paging cycle), and Ns (#POs/PF)>4. In other words, in '7, the number of PFs is less than that of the number of PFs in the legacy specification, and the number of POs for a PF is larger than the number of POs for a PF set forth in the legacy specification.

As described above, in certain example embodiments, the cell may indicate to the UE that the cell is operating in a clustered paging mode. In some example embodiments, this indication may be provided in a SIB, and the SIB may further indicate the clustered paging window configuration, the additional reference signal configuration (optional), and whether legacy UEs are allowed to camp on the cell or only the UEs supporting clustered paging window could camp on the cell (e.g., by setting the cell as barred for legacy UEs). In some example embodiments, if the legacy UEs can camp on the cell and monitor for paging, the network may still choose to use the clustered paging window for the UEs supporting it. Thus, the network may still obtain some clustering gain, and it may still operate with a longer SSB periodicity at the cost of increased legacy UE power consumption.

In certain example embodiments, the switch to the clustered paging mode may also trigger a change of SSB burst transmission periodicity, SIB transmission periodicity (e.g., to only provide SIB near/during the paging window), and RA occasions such that those occasions are located within/shortly after the clustered paging window. In doing so, it may be possible to reduce the latency between a UE that is paged, and until the UE can attempt RRC connection setup/resume.

As also described above, in some example embodiments, the cell may provide additional reference signals for synchronization in/before the paging window. In certain example embodiments, the additional reference signals may be PSS/SSS (i.e., the signals included in an SSB), or any other reference signal. In other example embodiments, the SSBs may also be clustered near the clustered paging window to improve the UEs' options for synchronization. That is, the duration between the SSB and the subsequent paging window may be as small as possible, but under the condition that SSB is before the paging window, and not after. In certain example embodiments, “near” may be defined as 0 or any non-zero value. However, it may be preferable for the value to be as low as possible to reduce the time UEs have to wakeup in advance, and enable the NW to sleep for a longer period of time outside this combined active time (SSB+paging window). Additionally, the cell may provide TRS to RRC idle/inactive UEs and, thus, the additional reference signal(s) may also be based on TRS. In other example embodiments, the network may not be interested in this unless there are also RRC connected UEs in need of the TRS. Furthermore, the additional reference signals may be located within and before the paging window to provide the best opportunities for the RRC idle/inactive UEs to quickly obtain synchronization before monitoring for paging.

According to certain example embodiments, as described above, the cell may be configured with a long SSB burst transmission periodicity (e.g., >20 ms) for energy savings. In certain example embodiments, depending on whether legacy UEs are supported, the cell may not be useful for an initial cell search.

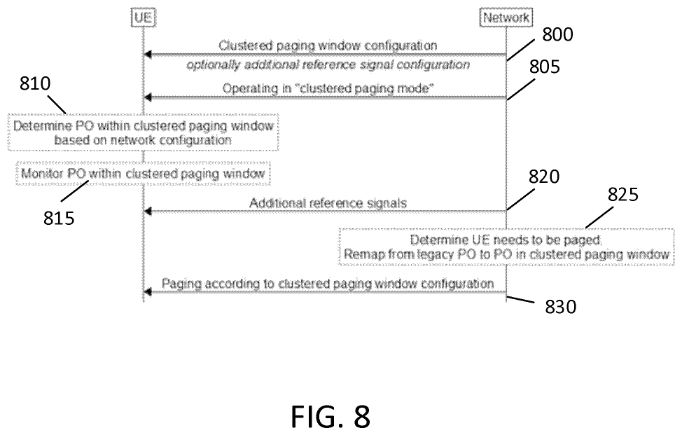

FIG. 8 illustrates an example signal flow diagram, according to certain example embodiments. In particular, the example of FIG. 8 illustrates a signaling diagram for the communication between a UE and the network providing the cell. For instance, at 800, the NW may transmit a clustered paging window configuration (e.g., dedicated RRC or SIB-based signaling) to the UE. In some example embodiments, the NW may also optionally transmit additional reference signal configuration to the UE along with the clustered paging window configuration. At 805, the NW may transmit an indication to the UE informing the UE that the NW is operating in a clustered paging mode. In some example embodiments, the indication may be via SIB or dedicated signaling (e.g., paging). At 810, the UE may determine a PO within the clustered paging window based on the received network configuration (i.e., paging window configuration), and at 815, the UE may monitor the PO within the clustered paging window. In other example embodiments, the UE may further monitor for reference signals (SSB or the additional reference signals) to ensure synchronization with the NW. In further example embodiments, if the UE detects that it is paged, the UE may follow legacy procedure and initiate a connection setup by, for example, starting RA procedure by transmitting RA preamble. At 820, the NW may optionally transmit additional reference signals to the UE, and at 825, determine whether the UE needs to be paged. At 825, the NW may also remap from the legacy PO to the PO in the clustered paging window. For instance, the legacy UE may monitor in a PO that is identified based on the UE ID. However, according to certain example embodiments, the UE may monitor only within the paging window, and still be based on the UE ID. Thus, in some example embodiments, the NW may determine what PO the UE is monitoring, and send the paging DCI there (i.e., perform a remapping from the legacy PO to a new PO location). At 830, the NW may perform a paging transmission according to the clustered paging window configuration.

As described above, in some example embodiments, the cell may configure the clustered paging operation on a separate carrier/BWP (separate from the carrier(s)/BWP(s) used for legacy users. In this case, legacy UEs may follow legacy paging operations, and new UEs may monitor paging on a dedicated carrier/BWP operating in clustered paging mode. In other example embodiments, one or more of the functions of the cell described above may be configured for this clustered paging carrier/BWP.

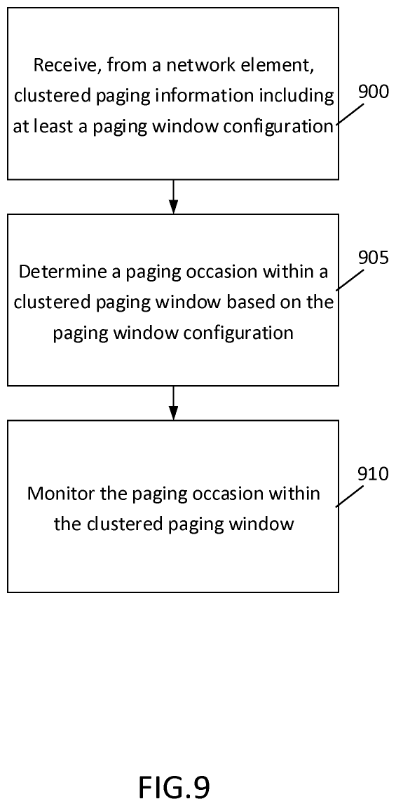

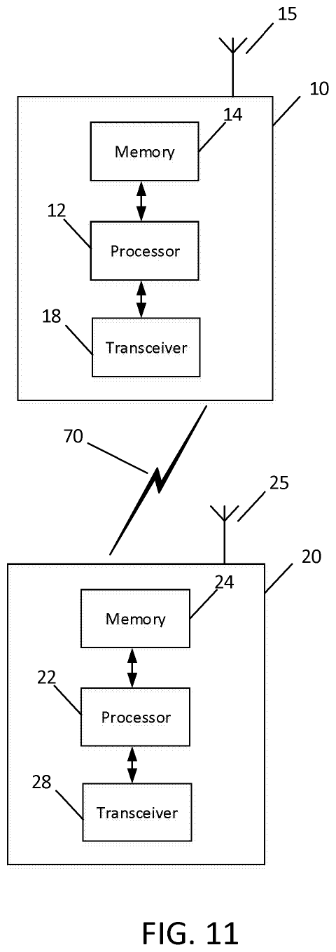

FIG. 9 illustrates an example flow diagram of a method, according to certain example embodiments. In an example embodiment, the method of FIG. 9 may be performed by a network entity, or a group of multiple network elements in a 3GPP system, such as LTE or 5G-NR. For instance, in an example embodiment, the method of FIG. 9 may be performed by a UE or device similar to one of apparatuses 10 or 20 illustrated in FIG. 11.

According to certain example embodiments, the method of FIG. 4 may include, at 900, receiving, from a network element, clustered paging information including at least a paging window configuration. The method may also include, at 905, determining a paging occasion within a clustered paging window based on the paging window configuration. The method may further include, at 910, monitoring the paging occasion within the clustered paging window.

According to certain example embodiments, the method may also include receiving an indication from the network element that the network element is operating in a clustered paging mode. According to other example embodiments, the method may further include determining a location of the clustered paging window in time domain. According to some example embodiments, the determining the location of the clustered paging window in time domain is based on a paging window start time provided in the clustered paging information. In certain example embodiments, the paging window start time may correspond to a radio frame, a subframe, or it may be relative to a paging cycle.

In some example embodiments, the method may also include determining at least one of a paging frame and a paging occasion within the clustered paging window based at least on the location of the clustered paging window in the time domain. In other example embodiments, the method may further include mapping a legacy paging occasion to the paging occasion within the clustered paging window by identifying the paging frame and the paging occasion within a paging frame of the clustered paging window based on the location of the clustered paging window in the time domain. In further example embodiments, the method may also include receiving a reference signal configuration specific to the clustered paging window in time domain, wherein the reference signal configuration includes one or more synchronization signals for synchronizing with the network element in or before the clustered paging window.

According to certain example embodiments, the method may further include receiving paging information from the network element based on the paging window configuration. According to some example embodiments, the method may also include receiving a synchronization signal and physical broadcast channel block burst transmitted with a periodicity that is greater than 20 ms. According to other example embodiments, the paging occasion may be monitored on a dedicated bandwidth part operating in the clustered paging mode. According to further example embodiments, the method may include initiating a random access in an occasion associated with the clustered paging window. According to some example embodiments, the method may also include determining the paging occasion based on a user equipment identification and the paging window configuration.

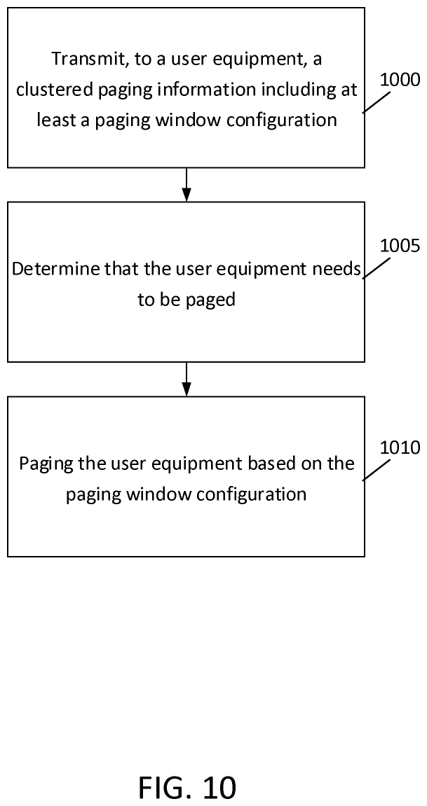

FIG. 10 illustrates an example of a flow diagram of another method, according to certain example embodiments. In an example embodiment, the method of FIG. 10 may be performed by a network entity, or a group of multiple network elements in a 3GPP system, such as LTE or 5G-NR. For instance, in an example embodiment, the method of FIG. 10 may be performed by a network, cell, or gNB similar to one of apparatuses 10 or 20 illustrated in FIG. 11.

According to certain example embodiments, the method of FIG. 10 may include, at 1000, transmitting, to a user equipment, a clustered paging information includes at least a paging window configuration. The method may also include, at 1005, determining that the user equipment needs to be paged. The method may further include, at 1010, paging the user equipment based on the paging window configuration. In some example embodiments, the clustered paging window may include one or more paging frames, or one or more paging occasions.

According to certain example embodiments, the method may further include transmitting an indication to the user equipment that a network element is operating in a clustered paging mode. According to some example embodiments, the transmission of the clustered paging information and the indication may be based on a system information broadcast or a dedicated signaling. According to other example embodiments, the method may also include transmitting a synchronization signal and physical broadcast channel block burst with a periodicity that is greater than 20 ms.

In certain example embodiments, the method may further include transmitting an indication to the user equipment that a network element is operating in a clustered paging mode. In some example embodiments, the method may also include transmitting a reference signal configuration that includes one or more synchronization signals for the user equipment to synchronize with the network element in or before the clustered paging window. In other example embodiments, operating in the clustered paging mode triggers a change of at least one of a synchronization signal and physical broadcast channel block, a system information broadcast transmission periodicity, or a random access occasion so that the random access occasion is located within or after the clustered paging window.

FIG. 11 illustrates a set of apparatus 10 and 20 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 11.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 11.

As illustrated in the example of FIG. 11, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 11, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-9.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-9.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element, clustered paging information comprising at least a paging window configuration. Apparatus 10 may also be controlled by memory 14 and processor 12 to determine a paging occasion within a clustered paging window based on the paging window configuration. Apparatus 10 may further be controlled by memory 14 and processor 12 to monitor the paging occasion within the clustered paging window.

As illustrated in the example of FIG. 11, apparatus 20 may be a network, core network element, or element in a communications network or associated with such a network, such as gNB. It should be noted that one of ordinary skill in the art would understand that apparatus 20 may include components or features not shown in FIG. 11.

As illustrated in the example of FIG. 11, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-8 and 10.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-8 and 10.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to transmit, to a user equipment, a clustered paging information comprising at least a paging window configuration. Apparatus 20 may also be controlled by memory 24 and processor 22 to determine that the user equipment needs to be paged. Apparatus 20 may further be controlled by memory 24 and processor 22 to page the user equipment based on the paging window configuration. According to certain example embodiments, the clustered paging window may include one or more paging frames, or one or more paging occasions.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a network element, clustered paging information comprising at least a paging window configuration. The apparatus may also include means for determining a paging occasion within a clustered paging window based on the paging window configuration. The apparatus may further include means for monitoring the paging occasion within the clustered paging window.

Certain example embodiments may also be directed to an apparatus that includes means for transmitting, to a user equipment, a clustered paging information comprising at least a paging window configuration. The apparatus may also include means for determining that the user equipment needs to be paged. The apparatus may further include means for paging the user equipment based on the paging window configuration. According to certain example embodiments, the clustered paging window may include one or more paging frames, or one or more paging occasions.

Certain example embodiments described herein provide several technical improvements, enhancements, and/or advantages. For instance, in some example embodiments, it may be possible for the network to concentrate all the paging transmissions within the smallest paging window, and in turn, the network may be able to sleep for longer periods of time outside such window when, for example, a long SSB transmission period is used, and in turn this would enable energy-efficient paging. In other example embodiments, the paging cycle may sufficiently short to serve voice calls since the paging delay for each UE may remain the same. According to further example embodiments it may be possible for the network to have more flexibility in adjusting the paging capacity to current needs by allocating resources within the paging window or configuring the window length according to those needs.

In certain example embodiments, additional advantages may be provided including, for example, the network having the ability to adjust the PRACH configuration by assigning RA occasions to respond to the paging to follow the window location (in time). This adjustment may enable the network to save energy by reducing preamble detection occasions. In some example embodiments, the network may be able to utilize a long SSB burst transmission periodicity without impacting the UEs' ability to synchronize. This may be accomplished, for example, by providing to the UE additional reference signals connected to the paging window. Certain example embodiments may further enable legacy UEs to operate on the cell configured with clustered paging mode.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
BS Base Station
BWP Bandwidth Part
DL Downlink
eNB Enhanced Node B
E-UTRAN Evolved UTRAN
gNB 5G or Next Generation NodeB
LTE Long Term Evolution
NR New Radio
NW Network
PBCH Physical Broadcast Channel
PF Paging Frame
PO Paging Occasion
PSS Primary Synchronization Signal
RRC Radio Resource Control
RS Reference Signal
SIB System Information Broadcast
SSB Synchronization Signal and PBCH Block
SSS Secondary Synchronization Signal
TRS Tracking Reference Signal
UE User Equipment
UL Uplink

1-59. (canceled)

60. An apparatus, comprising:
at least one processor; and
at least one memory comprising computer program code,
the at least one memory and the computer program code are configured, with the at least one processor to cause the apparatus at least to
receive, from a network element, clustered paging information comprising at least a paging window configuration;
determine a paging occasion within a clustered paging window based on the paging window configuration; and
monitor the paging occasion within the clustered paging window.

61. The apparatus according to claim 60, wherein the at least one memory and the computer program code are further configured, with the at least one processor to cause the apparatus at least to:
receive an indication from the network element that the network element is operating in a clustered paging mode.

62. The apparatus according to claim 60, wherein the at least one memory and the computer program code are further configured, with the at least one processor to cause the apparatus at least to:
determine a location of the clustered paging window in time domain.

63. The apparatus according to claim 62, wherein the determination of the location of the clustered paging window in time domain is based on a paging window start time provided in the clustered paging information.

64. The apparatus according to claim 60, wherein the at least one memory and the computer program code are further configured, with the at least one processor to cause the apparatus at least to:
determine at least one of a paging frame and a paging occasion within the clustered paging window based at least on the location of the clustered paging window in the time domain.

65. The apparatus according to claim 64, wherein the at least one memory and the computer program code are further configured, with the at least one processor to cause the apparatus at least to:
map a legacy paging occasion to the paging occasion within the clustered paging window by identifying the paging frame and the paging occasion within a paging frame of the clustered paging window based on the location of the clustered paging window in the time domain.

66. The apparatus according to claim 60, wherein the at least one memory and the computer program code are further configured, with the at least one processor to cause the apparatus at least to:
receive a reference signal configuration specific to the clustered paging window in time domain, wherein the reference signal configuration comprises one or more synchronization signals for synchronizing with the network element in or before the clustered paging window.

67. The apparatus according to claim 60, wherein the at least one memory and the computer program code are further configured, with the at least one processor to cause the apparatus at least to:
receive paging information from the network element based on the paging window configuration.

68. The apparatus according to claim 60, wherein the at least one memory and the computer program code are further configured, with the at least one processor to cause the apparatus at least to:
receive a synchronization signal and physical broadcast channel block burst transmitted with a periodicity that is greater than 20 ms.

69. The apparatus according to claim 60, wherein the paging occasion is monitored on a dedicated bandwidth part operating in the clustered paging mode.

70. The apparatus according to claim 60, wherein the at least one memory and the computer program code are further configured, with the at least one processor to cause the apparatus at least to:
initiate a random access in an occasion associated with the clustered paging window.

71. The apparatus according to claim 60, wherein the at least one memory and the computer program code are further configured, with the at least one processor to cause the apparatus at least to:
determine the paging occasion based on a user equipment identification and the paging window configuration.

72. An apparatus, comprising:
at least one processor; and
at least one memory comprising computer program code,
the at least one memory and the computer program code are configured, with the at least one processor to cause the apparatus at least to
transmit, to a user equipment, a clustered paging information comprising at least a paging window configuration;
determine that the user equipment needs to be paged; and
page the user equipment based on the paging window configuration,
wherein the clustered paging window comprises one or more paging frames, or one or more paging occasions.

73. The apparatus according to claim 72, wherein the at least one memory and the computer program code are further configured, with the at least one processor to cause the apparatus at least to:
transmit an indication to the user equipment that a network element is operating in a clustered paging mode.

74. The apparatus according to claim 72, wherein the transmission of the clustered paging information and the indication is based on a system information broadcast or a dedicated signaling.

75. The apparatus according to claim 72, wherein the at least one memory and the computer program code are further configured, with the at least one processor to cause the apparatus at least to:
transmit a synchronization signal and physical broadcast channel block burst with a periodicity that is greater than 20 ms.

76. The apparatus according to claim 72, wherein the at least one memory and the computer program code are further configured, with the at least one processor to cause the apparatus at least to:
transmit an indication to the user equipment that a network element is operating in a clustered paging mode.

77. The apparatus according to claim 72, wherein the at least one memory and the computer program code are further configured, with the at least one processor to cause the apparatus at least to:
transmit a reference signal configuration that comprises one or more synchronization signals for the user equipment to synchronize with the network element in or before the clustered paging window.

78. The apparatus according to claim 72, wherein operating in the clustered paging mode triggers a change of at least one of:
a synchronization signal and physical broadcast channel block,
a system information broadcast transmission periodicity, or
a random access occasion so that the random access occasion is located within or after the clustered paging window.

79. A method comprising:
receiving, from a network element, clustered paging information comprising at least a paging window configuration;
determining a paging occasion within a clustered paging window based on the paging window configuration; and
monitoring the paging occasion within the clustered paging window.
